(19) United States
(12) Patent Application Publication
(10) Pub. No.: US 2021/0115574 A1
(43) Pub. Date: Apr. 22, 2021

(54) SEALING COUPLING BETWEEN AT LEAST TWO PIPES OF AN ELECTROLYSIS SYSTEM THAT CAN BE MOUNTED ON ONE ANOTHER, AND USE THEREOF

(71) Applicant: THYSSENKRUPP UHDE CHLORINE ENGINEERS GMBH, Dortmund (DE)

(72) Inventors: Jörg KOLBE, Bochum (DE); Dmitri DONST, Köln (DE); Sebastian AUSTENFELD, Soest (DE); Peter TOROS, Essen (DE)

(73) Assignee: THYSSENKRUPP UHDE CHLORINE ENGINEERS GMBH, Dortmund (DE)

(21) Appl. No.: 16/608,918

(22) PCT Filed: Apr. 27, 2018
(86) PCT No.: PCT/EP2018/060869

§ 371 Date: Oct. 28, 2019

(30) Foreign Application Priority Data
Apr. 28, 2017 (DE) 10 2017 207 263.6

(51) Int. Cl. C25B 9/60; C25B 15/08; F16L 25/10; F16L 25/14; F16L 37/04; F16L 47/24; F16L 51/00

(52) U.S. Cl. CPC C25B 9/60; C25B 15/08; F16L 25/10; F16L 51/00; F16L 37/04; F16L 47/24; F16L 25/14

(57) ABSTRACT

A sealed coupling between at least two pipes may be mountable on one another in an electrolysis facility. The sealed coupling may be formed on at least one overlapping pipe pair by lateral surfaces abutting one another. The pipes may be mounted/mountable one inside the other in a floating manner relative to one another in an axial direction. A deformation point may be formed at a circumferential position having an axial length on a free end of the outer pipe in the overlap region. The deformation point may define a region for deformation of the outer pipe. A lateral surface of an inner lateral surface of the outer pipe and an outer lateral surface of the inner pipe may define a sealing surface that overlaps the deformation point in the axial direction. In addition to high operational reliability, this also enables a simplification of the installation procedure.

The invention relates to a sealed coupling between at least two pipes mountable on one another of an electrolysis facility, which are to be mounted on one another with a certain axial play relative to one another. Furthermore, the invention relates to the use of a pipe-in-pipe arrangement for providing such a sealing device. In particular, the invention relates to a sealed coupling according to the preamble of claim 1.

Sealing pipe-in-pipe connections are required in particular in electrolysis facilities. There are electrolysis facilities for obtaining chlorine, hydrogen, or sodium hydroxide. The respective materials are obtained in this case inside cells of the electrolysis facilities, and have to be conveyed out of the cells for the further use. Collecting channels made of metal are typically used for this purpose, which establish a connection to the respective cell via discharge pipes made of plastics.

Because of constricted space conditions and cost pressure, the connection between collecting channels and discharge pipe has to enable rapid and reliable installation, on the one hand, and also a sealed connection over the entire operating time of the cell, on the other hand. In particular the following factors can be obstacles to a good seal: different expansions in the case of collecting channel and discharge pipe, in particular at temperatures up to approximately 100° C., larger manufacturing tolerances in the case of plastic in comparison to metal. A universal connection with different geometries of the discharge pipes is also sought in particular in this case.

To satisfy as many of these requirements as possible, for example, a conical connecting piece is provided on the collecting channel, onto which the discharge pipe can be pushed. Good leak-tightness can be achieved with simple installation because of an axial pre-tension. However, it has been shown that this type of coupling is accompanied by disadvantages in particular in the case of temperature variations. At elevated temperatures, the discharge pipe made of plastic expands more strongly than the metallic components of the cell, so that the axial pre-tension increases. In some cases, it is then not possible to prevent bending of the discharge pipe from occurring from a critical pre-tension. This is accompanied by the risk that undesired contact occurs between discharge pipe and electrode, with the result of undersupply of the electrode with electrolytes and/or excessively high pressure on the membrane of the facility. Malfunctions and shortened service life accompanying this are to be avoided, however.

The object of the invention is to provide a device, whereby a seal having good operational reliability can be ensured in the case of pipes which are to be mounted on one another with a certain axial play relative to one another. In particular, it is the object to provide a coupling which can also ensure a reliable seal with respect to thermally-related relative movements or in the case of different materials of the coupling elements, in particular having high operational reliability over a long service life.

This object is achieved according to the invention by a sealed coupling between at least two pipes mounted/mountable on one another of an electrolysis facility, in particular between at least one discharge pipe connected to a cell of the electrolysis facility and at least one collecting pipe, wherein the sealed coupling is formed on at least one pipe pair in an overlap region of the pipes by lateral surfaces abutting one another, wherein the pipes of the (respective) pipe pair are mounted/mountable in a floating manner one inside the other in relation to one another in the axial direction to form a seal, wherein at least one intended deformation point is formed at a predefined circumferential position having predefined axial length on a free end of the outer pipe of the (respective) pipe pair in the overlap region, which intended deformation point defines a region for an (elastic) deformation of the outer pipe. This supplies high operational reliability in a broad temperature range.

In this case, at least one lateral surface of the inner lateral surface of the outer pipe and the outer lateral surface of the inner pipe can define a sealing surface, which sealing surface overlaps the intended deformation point in the axial direction, in particular in the direction axially inward into the pipe. The sealing surface can also be arranged here in a large component farther inward and/or farther away from the free end of the pipe than the intended deformation point. For example, the intended deformation point extends over a length z7, and the sealing surface extends over a length z11, z13, which is greater than the length z7 by the factor 1.5 to 3.

The pipes, in particular a plastic pipe and a metallic pipe, can adapt to one another based on elastic forces. The sealing effect can also firstly be completely achieved in this case, depending on the application, in the operating/working point, in particular if the final relative position of the pipes in relation to one another first results in a specific operating/working point. Pre-tension forces are thus not necessarily required during the installation. Rather, plugging together can take place without defined (pre-tension) force.

This is one of the advantages of the sealed coupling. The installation can be performed in a very simple manner, and the sealing can be performed by startup of the respective facility, without further interventions being required. The sealed coupling can thus be described as a self-sealing coupling which is self-locking in operation.

It has been shown that a satisfactory sealing effect can already be achieved from an overlap of approximately 3 mm, for example, at an internal diameter of the outer pipe in the range of 30 mm, i.e., approximately 10% overlap with respect to the absolute value of the diameter.

In particular, a reliable and leak-tight connection between a collecting channel and a discharge pipe in a facility for NaCI electrolysis can be ensured using this sealed coupling, which is also substantially independent of thermal expansions, discharge pipe lengths, or geometric shapes and/or can be implemented in a simple manner. The one pipe, in particular the discharge pipe, can be fastened on a flange in the lower part of a cell of an electrolysis facility. With this arrangement of the sealed coupling, a relative movement results between discharge pipe (in particular made of plastics) and cell (in particular made of metal) due to thermal expansion during operation of the cell (approximately 90° C.).

The axial floating mounting enables a relative displacement in this case, for example, in the case of temperature variations because of different coefficients of thermal expansion. This enables the tensions in the respective pipe to be minimized, in particular axial tensions and bending tensions. An at least approximately uniform leak-tightness can also be ensured in this case in a comparatively uncomplicated, robust manner.

The outer pipe (in particular made of PTFE) expands in the working point, for example, by approximately 10 mm in the longitudinal direction. The sealed coupling is configured to absorb such a length change, in particular a length change in the range of 0.8 to 1.2% of the length of the pipe.

In certain applications, the sealing effect only has to be ensured in certain states. This can be performed in particular by adapting the intended deformation points to further properties of the sealed coupling, for example, with respect to a slope of a conicity of one of the pipes. Upon reaching the working point, an elastic deformation of the plastic pipe results, which encloses the inner pipe to form a seal. The overlap region, in which a deformation and surface pressure takes place, does not always have to remain constant and can be selected so that the tolerances occurring in the production are also compensated for.

The sealing surface is preferably formed circumferentially, except for the intended deformation point(s) on the outer pipe.

According to one exemplary embodiment, multiple intended deformation points are provided, which are arranged circumferentially, in particular at uniform spacing in the circumferential direction. In this way, deformation forces and relative movements in the circumferential direction can be absorbed at different points.

According to one exemplary embodiment, at least one pair of intended deformation points arranged opposite to one another is provided, in particular diametrically. This provides a symmetrical arrangement, having comparatively homogeneous force distribution, and thus also a symmetrical load of the corresponding pipe, and thus also only little risk with respect to bending or buckling. Two or three diametric pairs can optionally also be provided. This can improve the deformation behavior. In particular, it can be ensured that a location change required in reaction to axial pre-tensions takes place symmetrically distributed over the circumference. The risk of buckling or bending thus decreases still further.

According to one exemplary embodiment, the (respective) intended deformation point is formed in the axial direction parallel to the/to a center longitudinal axis of the pipe.

Advantageous force relationships can be implemented in this way, and the sealing function can also be ensured over a comparatively large range of axial relative movements.

The respective intended deformation point can be formed as a compensation slot. The introduction of the compensation slots can be performed on the sealing end of the discharge pipe. The compensation slot is formed so that the discharge pipe, with an existing longitudinal expansion and also with respect to manufacturing deviations, conforms to the conical geometry of the inner pipe, in particular metallic pipe.

According to one exemplary embodiment, the (respective) intended deformation point comprises a compensation region, in particular a rounded recess at a lower, inner end of the intended deformation point. This can reduce or avoid tension peaks, in particular in a region of high local strains on the respective pipe. This can in particular prevent plastic deformations in the case of particularly large relative movements.

The compensation region can be dimensioned in dependence on the diameter of the pipe. In particular, a compensation borehole at the end of a slot can be dimensioned according to a ratio of borehole diameter to pipe diameter in the range of 0.03 to 0.1, in particular 0.05 (corresponding to 5%).

The depth of the intended deformation point (in particular in the embodiment as a slot) can be in the range of, for example, 5 to 10 mm, in particular 7 mm. For this example, the compensation region can be formed, for example, by a 1.5 mm borehole or a correspondingly round recess (radius) at the lower end of the slot.

According to one exemplary embodiment, the intended deformation point is configured for conical widening of the free end. This provides a high axial tolerance and can reduce bending and pre-tension forces.

According to one exemplary embodiment, a wall or the (outer) lateral surface of the inner pipe has a conicity, on which the sealing surface is formed, in particular at a free end of the pipe, in particular over a length section of at least 20 mm or at least 50% of the diameter of the outer pipe. A relaxation or a relief of the coupling can also take place in an advantageous manner in this way.

The conicity is, for example, in the range of 10 to 20°. The inclination of the lateral surface in relation to the center longitudinal axis is, for example, in the range of 5 to 10°. The conicity extends, for example, over a range of 35 to 45 mm.

The inner pipe has, for example, a maximum diameter in the range of 30 to 50 mm. A free end of the inner pipe has, for example, a diameter in the range of 25 to 35 mm.

According to one exemplary embodiment, the sealing surface defined by a/the conicity of a wall or the (outer) lateral surface of the inner pipe has a slope in the range of 10 to 20°, in particular at least 12° and at most 18°. This comparatively moderate slope provides comparable reaction forces substantially independently of the respective axial relative position.

For example, the conicity can be formed by an angle in the range of approximately 15°, in particular 15°+/−2.5°. It has been shown that with this embodiment of the conicity, a good sealing effect can be ensured in conjunction with a strain of the intended deformation point(s) which is not excessively high.

According to one exemplary embodiment, the inner pipe has a free end on which one or more pins or tabs or projections are formed, which are geometrically delimited from the sealing surface. In this way, an insertion aid for the coupling procedure can be provided in a simple manner, and at the same time a clear functional separation can also be produced between pipe sections provided for the installation and pipe sections provided for the sealing.

For example, two tabs are provided, which protrude in the axial direction approximately 10 to 20 mm, wherein a conicity of the lateral surface is preferably also formed on the tabs.

According to one exemplary embodiment, both the inner lateral surface of the outer pipe and also the outer lateral surface of the inner pipe define a/the sealing surface, which overlap the intended deformation point axially in the direction inward, so that a seal is ensured farther inward than the intended deformation point. In this way, the sealing effect can be ensured independently of a load state of the intended deformation point. This is advantageous in particular if the intended deformation point is formed as a slot.

According to one exemplary embodiment, the inner lateral surface of the outer pipe defines a/the sealing surface, which is arranged farther inward than the intended deformation point, wherein the outer lateral surface of the inner pipe defines a/the sealing surface, which extends up to a free end of the inner pipe. The seal can be displaced far inward in this case, i.e., where a sealing contact can be ensured with comparatively high consistency and independently of the degree of the axial overlap.

The respective surface preferably has no interruptions or irregularities at all, except for intended deformation points. The surfaces or sealing surfaces are preferably formed rotationally-symmetrical around the entire circumference.

According to one exemplary embodiment, the intended deformation point has an axial length which is in the range of 10 to 30% of the diameter of the outer pipe, in particular 15 to 25%. In this way, a good compromise can be ensured between axial movement tolerance and intrinsic stability and/or achievable surface pressure.

The depth of the intended deformation point, in particular in the form of a slot, is, for example, 7 mm at the lowest point. A compensation borehole/rounding, for example, having 1.5 mm diameter, can be provided there. Still further factors can also be taken into consideration in the reconciliation of the size ratios, for example, the angle of a conicity. Fine-tuning can be performed depending on the material pairing and usage case (in particular temperature variations) and length and diameter of the pipes. It has been shown that the size ratios mentioned here can also ensure a good sealing effect in the case of scaling.

According to one exemplary embodiment, the intended deformation point is larger and/or wider than 0.3 mm or greater than 1% of the diameter of the outer pipe in the circumferential direction. This enables sufficient deformation even with comparatively inelastic materials.

According to one exemplary embodiment, the intended deformation point, in the circumferential direction, is smaller and/or narrower than 1 mm or less than 5% of the diameter of the outer pipe. In this way, on the one hand, a large amount of material and/or surface can be preserved, on the other hand, tilting can be avoided and/or good accessibility to a compensation region or the arrangement and introduction of the compensation region with the least possible tension can be enabled.

According to one exemplary embodiment, the intended deformation point (in the final-installed state or in the operating state) is overlapped in the axial direction by the inner pipe by at least 5% of the diameter of the outer pipe or at least 3 mm, in particular by at least 10%. In this way, a sufficient seal can be produced in a region axially adjacent to the intended deformation point even in the case of comparatively strong relative movements.

According to one exemplary embodiment, the sealing surface overlaps the intended deformation point in the axial direction by at least 3 mm or at least 5% of the diameter of the outer pipe to the inside, in particular by at least 10%. This provides a good sealing effect, substantially independently of the type of the relative movement in the intended deformation point.

According to one exemplary embodiment, the respective intended deformation point is formed as a compensation slot having a hole as a compensation region. In this way, a simple, robust structure can be provided to the intended deformation point. The deformation behavior can also be predefined in a comparatively simple manner.

According to one exemplary embodiment, the sealed coupling is formed by a friction-locked, axially-tolerant pipe-in-pipe arrangement configured to seal upon friction lock by elastic deformation. The above-mentioned advantages result in this way.

According to one exemplary embodiment, one pipe of the pipe pair or at least its free end consists of metal and the other pipe of the pipe pair or at least its free end consists of plastic, in particular of PTFE. In particular, the outer pipe can be embodied completely from plastic, without a risk of plastic bending over or buckling existing.

According to one exemplary embodiment, the sealed coupling is configured for axial relative movements of the pipes of a pipe pair in relation to one another in the range of 5 to 15 mm or 20 to 40% of the diameter of the inner pipe, in particular 10 mm or 30% of the diameter of the inner pipe. This provides a high level of operational reliability even in the event of comparatively strong axial relative movements and/or in a broad temperature range.

The above-mentioned object is also achieved according to the invention by a sealed coupling between at least two pipes mounted on one another of an electrolysis facility, in particular by an above-described sealed coupling, produced by coupling two pipes at the free ends thereof on lateral surfaces abutting one another and by mounting the pipes in a floating manner relative to one another by means of the coupling, wherein the sealing occurs in the overlap region of the pipes, and wherein at least one intended deformation point is arranged on at least one predefined circumferential position having predefined axial length in the overlap region, by means of which intended deformation point abutting of the lateral surfaces on one another to form a seal is ensured in the case of at least approximately uniform axial pre-tension force on the overlap region even in the event of axial displacement of the pipes relative to one another. This provides the above-mentioned advantages.

According to one exemplary embodiment, the sealed coupling is configured and/or formed as a self-locking thermal expansion coupling which is axially mounted in a floating manner, in particular having a coefficient of thermal expansion of the outer pipe greater than a coefficient of thermal expansion of the inner pipe. This provides the above-mentioned advantages. In this case, the outer pipe can consist of a material which is softer than the material of the inner pipe. A deformation then takes place predominantly or exclusively in the outer pipe. In this case, the intended deformation points can act particularly effectively.

The above-mentioned object is achieved according to the invention by use of a pipe-in-pipe arrangement as a sealed coupling between at least one pipe made of metal and at least one pipe made of plastic in an electrolysis facility, in particular of an inner overlapping collecting pipe made of metal and an outer overlapping discharge pipe made of plastic, wherein the outer pipe made of plastic having slotted intended deformation points is axially mounted in a floating manner on a conical sealing surface of the inner pipe made of metal in an overlap region and sealed by surface pressure. This provides the above-described advantages.

Further features and advantages of the invention result from the description of at least one exemplary embodiment on the basis of drawings, and from the drawings themselves.

Reference is made to the other figures in the case of reference signs which are not described explicitly with respect to an individual figure. In this case, the respective schematic figures

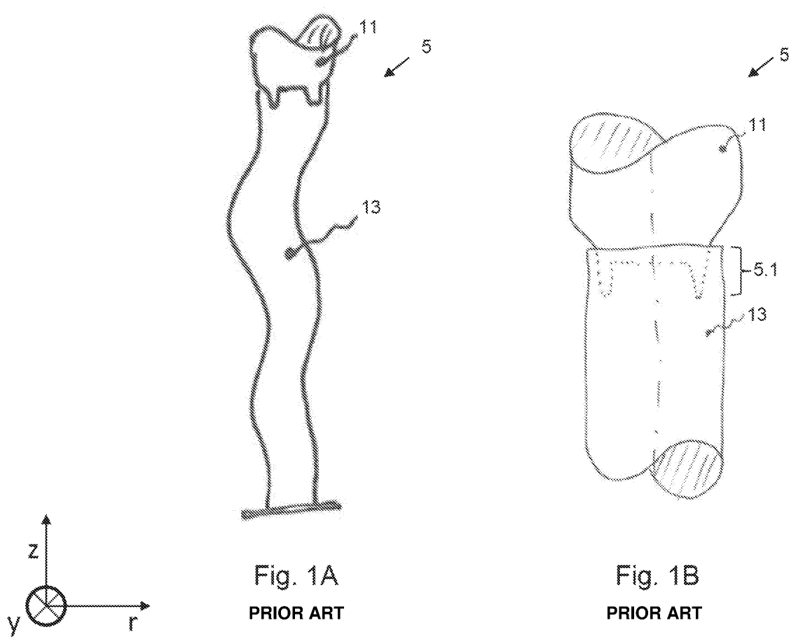

FIGS. 1A, 1B each show a side view of a previously known, conical pipe-in-pipe arrangement according to the prior art,

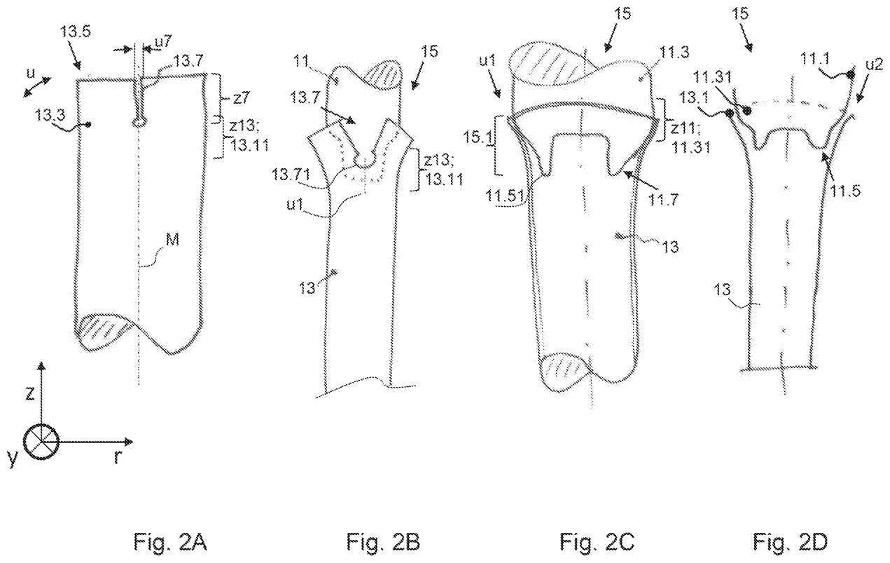

FIGS. 2A, 2B, 2C, 2D each show a side view of a sealed coupling according to one exemplary embodiment, and

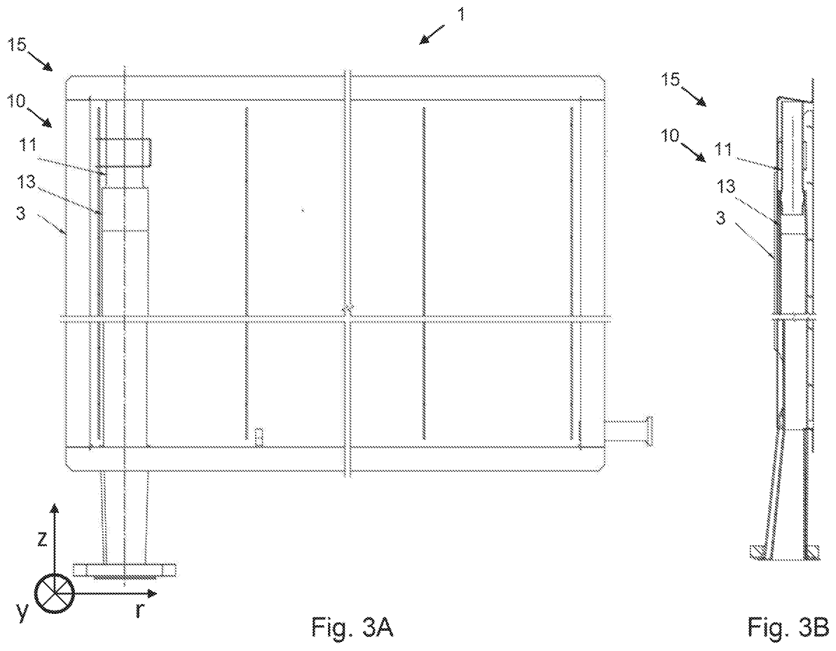

FIGS. 3A, 3B show, in a side view and in a sectional view according to the dotted line of section, a part of an electrolysis facility having a cell having a sealed coupling installed therein according to one exemplary embodiment.

FIGS. 1A, 1B show a pipe-in-pipe arrangement 5 having an inner pipe 11 and an outer pipe 13, which overlap one another in an overlap region 5.1. In this case, sealing takes place on a respective conical lateral surface of the pipes, on which an (inner) sealing surface and an (outer) sealing surface is respectively formed. With increasing overlap, the sealing surface becomes larger, in particular proportionally. Because of the conicity of the inner pipe 11, the tensions in the pipes increase strongly in this case, possibly also disproportionately. It can also be unfavorable or disadvantageous in this case that the leak-tightness becomes worse and worse at the bottom of the interface at the free end of the inner pipe the larger the overlap becomes. The sealing point is displaced away from the actual interface between inner and outer pipe. This can have technically disadvantageous effects, in particular if the outer pipe loses elasticity over time. It has also been shown that in arrangements in which the pipes tilt relative to one another or are aligned at least in a small angle range relative to one another, sealing cannot be ensured with good reliability. In this case, high bending tensions can also be induced, which reduces the operational reliability.

FIGS. 2A, 2B, 2C, 2D show a sealed coupling 10 having a pipe-in-pipe arrangement 15 extending along a center longitudinal axis M having an inner (first) pipe 11, in particular a collecting pipe in a cell of an electrolysis facility, and an outer (second) pipe 13, in particular a discharge pipe, which pipes together form the pipe-in-pipe arrangement 15 having an overlap region 15.1.

A sealing surface 11.31, 13.11 is formed on the two pipes 11, 13, respectively having the axial extension z11, z13. The inner pipe 11 is formed conically at a free end 11.5. The conicity 11.7 also extends in this case up to tabs 11.51 at the free end. The sealing occurs on an outer lateral surface 11.3 of the inner pipe 11 and on an inner lateral surface 13.1 of the outer pipe 13. No contact takes place on an outer lateral surface 13.3 of the outer pipe 13 and on an inner lateral surface 11.1 of the inner pipe 11.

Two intended deformation points 13.7 extending in the axial z direction are formed on the outer pipe 13, respectively at a circumferential position u1, u2, in particular diametrically opposing, i.e., offset by 180° in the circumferential direction u. In the circumferential direction u, the respective intended deformation point 13.7 has a uniform width u7, except for a rounded, in particular circular compensation region 13.71, which is formed on a base or bottom of the intended deformation point 13.7.

The intended deformation point 13.7 overlaps the sealing surface 13.11 in the axial direction. The sealing surface 13.11 extends farther in the axial direction than the intended deformation point 13.7. The intended deformation point 13.7 is formed as a slot in the axial direction at a free end of the pipe 13. The axial extension or length z7 of the intended deformation point 13.7 is in the range of 10 to 30% of the diameter of the outer pipe.

In this sealed coupling 10, an elastic deformation is possible in the region of the intended deformation point 13.7 in the event of axial relative movement of the pipes 11, 13. A surface pressure, which is advantageous for the sealing effect, on the sections of the lateral surfaces abutting one another can be ensured by the pre-tension of the outer pipe 13.

FIGS. 3A, 3B schematically show an electrolysis facility 1 having one cell or multiple cells 3, in each of which at least one sealed coupling 10 can be provided. In this application of the sealed coupling 10, the outer discharge pipe 13 can be formed from plastic in particular, and the inner collecting pipe 11 can be a comparatively short pipe connecting piece, in particular made of metal. Thermally-related location changes then take place above all in the discharge pipe 13 according to experience.

The following is also to be noted with respect to the functionality of the electrolysis facility 1: The cell 3 consists of two halves, of which only one half is shown in FIG. 3B. The two halves are laid one on top of another and screwed together to form a seal. An outlet connecting piece or outlet out of the cell is located on the bottom (FIG. 3B) or on the bottom left (FIG. 3A). The so-called discharge pipe 13 is inserted into the outlet connecting piece and connected or coupled at its upper end to the metallic collecting pipe or connecting piece 11. In operation, the cell 3 fills up with liquid, up to the top. The connecting piece 11 then assumes the function of an overflow, in the manner of a pipe draining out of the cell or electrolysis facility, and the liquid can reach the outlet via the discharge pipe 13. It is thus important that leak-tightness can be ensured at this coupling between connecting piece 11 and discharge pipe 13, even in the event of comparatively large location changes and/or tension variations.

List of reference signs:

1 electrolysis facility

3 cell

5 pipe-in-pipe arrangement

5.1 overlap region

10 sealed coupling

11 inner (first) pipe, in particular collecting pipe

11.1 inner lateral surface

11.3 outer lateral surface

11.31 sealing surface

11.5 free end

11.51 tab

11.7 conicity

13 outer (second) pipe, in particular discharge pipe

13.1 inner lateral surface

13.11 sealing surface

13.3 outer lateral surface

13.5 free end

13.7 intended deformation point

13.71 compensation region

15 pipe-in-pipe arrangement

15.1 overlap region

M center longitudinal axis

u1, u2 circumferential position

u7 extension of the intended deformation point in the circumferential direction

z7 axial extension of the intended deformation point

z11 axial extension of the (inner) sealing surface

z13 axial extension of the (outer) sealing surface

r, y radial direction

u circumferential direction

z axial direction

1.-15. (canceled)

16. A sealed coupling that is positionable between at least two pipes of an electrolysis facility that are either mounted or mountable to one another, wherein the sealed coupling is formed on the at least two pipes in an overlap region of the at least two pipes by lateral surfaces abutting one another, wherein an inner pipe of the at least two pipes is either mounted or mountable inside an outer pipe of the at least two pipes in a floating manner to form a seal between the at least two pipes in an axial direction, wherein a deformation point is disposed at a predefined circumferential position having an axial length on a free end of the outer pipe in the overlap region.

17. The sealed coupling of claim 16 wherein the at least two pipes comprise a discharge pipe connected to a cell of the electrolysis facility and a collecting pipe.

18. The sealed coupling of claim 16 wherein the deformation point is one of a plurality of deformation points disposed circumferentially or wherein the deformation point is one of a pair of deformation points that are disposed opposite one another.

19. The sealed coupling of claim 16 wherein at least one of:
a lateral surface of an inner lateral surface of the outer pipe and an outer lateral surface of the inner pipe define a sealing surface that overlaps the deformation point in the axial direction;
both the inner lateral surface of the outer pipe and the outer lateral surface of the inner pipe define a sealing surface that overlaps the deformation point axially in an inward direction; or
the inner lateral surface of the outer pipe defines a sealing surface that is disposed farther inward than the deformation point and the outer lateral surface of the inner pipe defines a sealing surface that extends up to a free end of the inner pipe.

20. The sealed coupling of claim 16 wherein the deformation point comprises a compensation region or is configured for a conical widening of a free end of the outer pipe.

21. The sealed coupling of claim 16 wherein at least one of:
a wall, an inner lateral surface, or an outer lateral surface of the inner pipe has a conicity on which a sealing surface is formed; or
a sealing surface defined by a conicity of a wall or a lateral surface of the inner pipe has a slope in a range of 10° to 20°.

22. The sealed coupling of claim 16 wherein the axial length of the deformation point is in a range of 10% to 30% of a diameter of the outer pipe.

23. The sealed coupling of claim 16 wherein at least one of
the deformation point in a circumferential direction is larger than 0.3 mm or greater than 1% of a diameter of the outer pipe; or
the deformation point in a circumferential direction is smaller than 1 mm or less than 5% of the diameter of the outer pipe.

24. The sealed coupling of claim 16 wherein at least one of:
the deformation point is overlapped in the axial direction by the inner pipe by at least 5% of a diameter of the outer pipe or at least 3 mm; or
a sealing surface overlaps the deformation point inward in the axial direction by at least 3 mm or at least 5% of the diameter of the outer pipe.

25. The sealed coupling of claim 16 wherein the deformation point is formed as a compensation slot having a hole as a compensation region.

26. The sealed coupling of claim 16 formed by a friction-locked, axially-tolerant pipe-in-pipe arrangement configured to seal upon friction lock by elastic deformation.

27. The sealed coupling of claim 16 wherein a first of the at least two pipes comprises metal and a second of the at least two pipes comprises plastic.

28. The sealed coupling of claim 16 configured for axial relative movements of the at least two pipes relative to one another in a range of 5 to 15 mm or 20% to 40% of a diameter of the inner pipe.

29. A sealed coupling between at least two pipes of an electrolysis facility that are mounted on one another, the sealed coupling comprising two pipes that are coupled at free ends thereof on lateral surfaces abutting one another, wherein the two pipes are mounted in a floating manner relative to one another by way of the sealed coupling, wherein the sealed coupling is in an overlap region of the two pipes, wherein a deformation point is disposed on at least one predefined circumferential position having a predefined axial length in the overlap region, by way of which the deformation point abutting of the lateral surfaces on one another to form a seal is ensured with approximately uniform axial pre-tension force on the overlap region in an event of axial displacement of the two pipes relative to one another.

30. The sealed coupling of claim 29 configured as a self-locking coupling, the sealed coupling being mounted in a floating manner axially and being tolerant of thermal expansion.

31. The sealed coupling of claim 29 wherein a coefficient of thermal expansion of the outer pipe is greater than a coefficient of thermal expansion of the inner pipe.

32. A pipe-in-pipe arrangement configured as a sealed coupling, which is tolerant of thermal expansion, between a first pipe comprised of metal and a second pipe comprised of plastic in an electrolysis facility, wherein the first pipe is an interior overlapping collecting pipe and the second pipe is an exterior overlapping discharge pipe, wherein the second pipe has slotted deformation points, is axially mounted in a floating manner on a conical sealing surface of the first pipe in an overlap region, and is sealed by surface pressure.
